(19) United States
(12) Patent Application Publication
(10) Pub. No.: US 2022/0042175 A1
(43) Pub. Date: Feb. 10, 2022

(54) STAINLESS STEEL STRUCTURE EXCELLENT IN HYDROGEN EMBRITTLEMENT RESISTANCE AND CORROSION RESISTANCE AND METHOD FOR MANUFACTURING THE SAME

(71) Applicants: Asahimekki Corporation, Tottori (JP); The University of Electro-Communications, Tokyo (JP); National Institute of Advanced Industrial Science and Technology, Tokyo (JP); Tottori Institute of Industrial Technology, Tottori (JP)

(72) Inventors: Kazuyoshi KAWAMI, Tottori (JP); Atsushi KINOSHITA, Tottori (JP); Takashi YAMANAKA, Tottori (JP); Yoji FUKUDA, Tottori (JP); Motonori TAMURA, Tokyo (JP); Takashi IIJIMA, Ibaraki (JP); Hirotoshi ENOKI, Ibaraki (JP); Hiroyasu TAMAI, Tottori (JP); Mutsuharu IMAOKA, Tottori (JP); Takeshi FUKUTANI, Tottori (JP); Toshiyuki TANAKA, Tottori (JP); Yoshiaki SUZUKI, Tottori (JP)

(73) Assignees: Asahimekki Corporation, Tottori (JP); The University of Electro-Communications, Tokyo (JP); National Institute of Advanced Industrial Science and Technology, Tokyo (JP); Tottori Institute of Industrial Technology, Tottori (JP)

(21) Appl. No.: 17/393,789

(22) Filed: Aug. 4, 2021

(30) Foreign Application Priority Data
Aug. 5, 2020 (JP) 2020-133347

(51) Int. Cl. C23C 22/78; C23C 22/50; C23C 26/00; C23C 28/04

(52) U.S. Cl. CPC C23C 22/78; C23C 22/50; C25F 3/24; C23C 28/04; C23C 26/00

(57) ABSTRACT

[Problem] To propose a stainless steel structure excellent in hydrogen embrittlement resistance and corrosion resistance, being high in mass productivity, simple in device structure, low in equipment cost, and having a high cost advantage, and a method for manufacturing the same.

[Solving means] It is stainless steel having hydrogen embrittlement resistance and corrosion resistance, a surface of electrolytically polished stainless steel being coated with a film obtained by passivating a metal oxide formed by a wet process, wherein the film thickness of the film obtained by passivating the metal oxide formed by a wet process is greater than 100 nm. A hydrogen permeability ratio (film-formed product/film-unformed product) is equal to or less than 2.0×10⁻², and a relative reduction of area (under a hydrogen atmosphere of 110 MPa/under a nitrogen atmosphere of 10 MPa) in an SSRT test is equal to or greater than 0.8. It includes a polishing treatment step, a film-forming step, a curing treatment step, and a passivation treatment step, and the passivation treatment step consists of at least two or more independent passivation treatment steps.

### DETAILED DESCRIPTION OF THE INVENTION

### Technical Field

The present invention relates to a stainless steel structure excellent in hydrogen embrittlement resistance and corrosion resistance, and a method for manufacturing the same. It relates in particular to a stainless steel structure excellent in hydrogen embrittlement resistance and corrosion resistance, being coated with a functional membrane obtained by passivating a metal oxide film formed on a surface of the stainless steel structure by a wet process, and a method for manufacturing the same.

### BACKGROUND ART

An approach has been taken to realize a hydrogen energy based society where hydrogen is utilized as an environment-friendly energy source for the next generation. In order to realize the hydrogen energy based society, it is necessary to develop a storage and transportation technology for a stable supply of hydrogen.

A metallic material is used for a steel structure for hydrogen such as a high-pressure storage container for storing hydrogen or a high-pressure pipe line for transporting hydrogen. In particular, under a high-pressure hydrogen environment, there is a problem of hydrogen embrittlement that is caused by penetration of hydrogen into the metallic material, and thus a steel structure (e.g., SUS316L) or an aluminum alloy (e.g., A6061-T6) that is excellent in hydrogen embrittlement resistance, is used (Non-patent document 1).

In addition, because the steel structure for hydrogen is often subjected to welding, it is not enough just to be excellent in hydrogen embrittlement resistance but is required to be excellent in corrosion resistance of a welded part. Thus, coating the steel structure for hydrogen with a film to give hydrogen embrittlement resistance and corrosion resistance is under consideration.

A method for forming a film on a surface of a metallic material includes a dry process (dry type treating method) using no aqueous solution and a wet process (wet type treating method) using an aqueous solution. The dry process includes a vacuum evaporation (VE), a physical vapor deposition (PVD) that deposits a thin film of a target material on a surface of a material in a vapor phase by a physical method, and a chemical vapor deposition (CVD) that supplies material gas containing a component of a target thin film and deposits a film by chemical reaction on a substrate surface or in a vapor phase.

On the other hand, the wet process includes electrolytic plating, non-electrolytic plating, anodic oxidation, chemical conversion treatment, and electrodeposition coating. The wet process has two major features compared with the dry process: one is that it can treat a larger area, is higher in mass productivity, and lower in treatment cost, and the other is that it is an atmospheric open system, simpler in device structure, and lower in equipment cost.

It is known that dense oxide and nitride that are formed on a surface of a metallic material are excellent in hydrogen barrier property. Thus, Patent Document 1 discloses forming a film made by laminating a chromium oxynitride film and a ceramic film and having a hydrogen barrier function, on a surface of a metallic material (stainless steel or chrome molybdenum steel) by VE or PVD, Patent Document 2 discloses heating stainless steel to 200-400° C. under an atmospheric pressure pure oxygen atmosphere to form an oxide film on its surface, and Patent Document 3 discloses forming an aluminum oxide (Al₂O₃) film by a sputtering method and a silicon nitride (Si₃N₄) film by a plasma CVD method, on a metallic material surface. However, as mentioned above, the formation of the oxide film or nitride film by the dry process has a problem that treatment costs are high, mass production is difficult, and productivity is inferior, because it is necessary to evaporate or ionize a film-forming material. In addition, it also has a problem that device structure is complicated, equipment costs are high, and a cost advantage is inferior, because of a closed system process.

On the other hand, the wet process has the advantage that both the productivity and cost advantage are high compared to the dry process since it is a method that immerses a metallic material in an aqueous solution containing a film-forming material. For a method for forming a film on a metallic surface by the wet process, Patent Document 4 discloses forming a film of nickel, zinc, and copper having a thickness of 0.10 μm to 50 μm by nickel plating, zinc plating, and copper plating, on a surface of a steel material to be brought into contact with hydrogen gas, by electroplating.

In addition, Patent Document 5 discloses a stainless steel material excellent in hydrogen embrittlement resistance by forming a dense oxide film having a hydrogen barrier function on a surface of the stainless steel material by a wet process. However, the thickness of the dense oxide film having a hydrogen barrier function is equal to or less than 100 nm, and thus there is room for improving the hydrogen embrittlement resistance by increasing the thickness of the film.

### PRIOR ART DOCUMENT

### Patent Document

Patent Document 1: Japanese Patent Application Laid-Open No. 2014-214336
Patent Document 2: Japanese Patent Application Laid-Open No. Hei04-157149
Patent Document 3: Japanese Patent Application Laid-Open No. 2016-53209
Patent Document 4: Japanese Patent Application Laid-Open No. 2016-65313
Patent Document 5: Japanese Patent Application Laid-Open No. 2018-188728

### Non-Patent Document

Non-Patent Document 1: Motonori TAMURA, Koji SHIBATA: “Journal of the Japanese Institute of Metals and Materials,” Volume 69, No. 12 (2005), Pp. 1039-1048

### SUMMARY OF THE INVENTION

### Problems to be Solved by the Invention

The present invention proposes a stainless steel structure excellent in hydrogen embrittlement resistance and corrosion resistance being coated with a functional membrane obtained by passivating a metal oxide film formed on a surface of the stainless steel structure by a wet process that can treat a large area, is high in mass productivity, low in treatment cost, high in productivity, and is an atmospheric open system, simple in device structure, low in equipment cost, and has a high cost advantage, and a method for manufacturing the same. In addition, it also proposes a method for manufacturing a steel structure for hydrogen excellent in hydrogen embrittlement resistance and corrosion resistance by forming a functional membrane obtained by passivating a metal oxide film, on a surface of the steel structure for hydrogen subjected to welding.

### Means for Solving the Problems

The problem of the present invention can be solved by the specific following aspects.

(Aspect 1) It is stainless steel having hydrogen embrittlement resistance, a surface of electrolytically polished stainless steel being coated with a film obtained by passivating a metal oxide film, wherein a relative reduction of area (under a hydrogen atmosphere of 110 MPa/under a nitrogen atmosphere of 10 MPa) in an SSRT test (strain rate 4.17×10⁻⁵/sec, test temperature 16° C.) is equal to or greater than 0.8.

This is because electrolytic polishing of the surface of the stainless steel smoothens the surface of the stainless steel, the thickness of the film formed on the smoothened surface of the stainless steel becomes uniform, and a thin part of the film or a film defect (pinhole), which may cause reduction in hydrogen embrittlement resistance, does not occur. In addition, this is because the surface of the stainless steel is smoothened and film adhesiveness of the film obtained by passivating the metal oxide formed by a wet process to the surface of the stainless steel is improved. This is because the relative reduction of area in the SSRT test is an indicator of hydrogen embrittlement resistance and being equal to or greater than 0.8 can provide a stainless steel material and stainless steel structure that are very excellent in hydrogen embrittlement resistance.

(Aspect 2) It is the stainless steel having hydrogen embrittlement resistance according to aspect 1, a relative reduction of area (under a hydrogen atmosphere of 110 MPa/under a nitrogen atmosphere of 10 MPa) in an SSRT test (strain rate 4.17×10⁻⁵/sec, test temperature 16° C.) being equal to or greater than 0.8, wherein the electrolytically polished stainless steel is stainless steel subjected to welding.

This is because a steel structure for hydrogen subjected to welding also needs performance to meet hydrogen embrittlement resistance to satisfy the aspect 1.

(Aspect 3) It is a method for manufacturing stainless steel having hydrogen embrittlement resistance, the stainless steel being coated with a film obtained by passivating a chromium oxide film, a relative reduction of area (under a hydrogen atmosphere of 110 MPa/under a nitrogen atmosphere of 10 MPa) in an SSRT test (strain rate 4.17×10⁻⁵/sec, test temperature 16° C.) being equal to or greater than 0.8, the method comprising: a polishing treatment step of electrolytically polishing a surface of the stainless steel; a film-forming step of immersing the polished stainless steel in a treatment solution comprising a mixed solution containing chromic acid and sulfuric acid to form a chromium oxide film on the surface of the stainless steel; a curing treatment step of immersing the chromium oxide film formed in the film-forming step in a treatment solution comprising a mixed solution containing chromic acid and phosphoric acid to cure the chromium oxide film; and a passivation treatment step of immersing the chromium oxide film cured in the curing treatment step in a treatment solution comprising a passivating agent to passivate the chromium oxide film, wherein the passivation treatment step consists of at least two or more independent passivation treatment steps.

This is because electrolytic polishing of the surface of the stainless steel smoothens the surface of the stainless steel, the thickness of the film formed on the smoothened surface of the stainless steel becomes uniform, and a thin part of the film or a film defect (pinhole), which may cause reduction in hydrogen embrittlement resistance, does not occur. Then, this is because the hydrogen embrittlement resistance of the passivated passivation film to be formed on the surface of the stainless is improved. In addition, by making the steps all wet processes, a large area can be treated, mass productivity becomes high, treatment costs become low, and productivity becomes high. In addition, this is because it is possible to manufacture stainless steel having hydrogen embrittlement resistance that has a high cost advantage and is low in treatment cost since also a device structure is simple and equipment costs are low.

Further, this is because by making the passivation treatment step at least two or more independent passivation treatment steps and sequentially adding the passivation treatments, denseness of the passivated chromium oxide film having a film thickness of greater than 100 nm is improved (for example, increase in pitting potential) to improve hydrogen embrittlement resistance.

(Aspect 4) It is the method for manufacturing stainless steel having hydrogen embrittlement resistance, a relative reduction of area (under a hydrogen atmosphere of 110 MPa/under a nitrogen atmosphere of 10 MPa) in an SSRT test (strain rate 4.17×10⁻⁵/sec, test temperature 16° C.) being equal to or greater than 0.8, according to aspect 3, wherein the two or more independent passivation treatment steps are each passivation treatment step of immersing in treatment solutions comprising passivating agents different in component to passivate the chromium oxide film.

This is because by changing components of the passivating agent, sequentially the passivation at each treatment step of the passivation treatment properly proceeds and denseness of the passivated chromium oxide film having a film thickness of greater than 100 nm is improved (for example, increase in pitting potential) to improve hydrogen embrittlement resistance.

(Aspect 5) It is the method for manufacturing stainless steel having hydrogen embrittlement resistance, a relative reduction of area (under a hydrogen atmosphere of 110 MPa/under a nitrogen atmosphere of 10 MPa) in an SSRT test (strain rate 4.17×10⁻⁵/sec, test temperature 16° C.) being equal to or greater than 0.8, according to any of aspect 3 or aspect 4, wherein the electrolytically polished stainless steel is stainless steel subjected to welding.

This is because a manufacturing method that assures the hydrogen embrittlement resistance satisfying the aspect 3 or aspect 4 is needed in order to give hydrogen embrittlement resistance to a steel structure for hydrogen subjected to welding.

### Advantageous Effect of the Invention

According to the present invention, it is possible to provide a stainless steel structure being coated with a functional membrane having a membrane thickness of greater than 100 nm and being excellent in hydrogen embrittlement resistance and corrosion resistance by passivating a metal oxide film formed on a surface of the stainless steel structure by a wet process that can treat a large area, is high in mass productivity, low in treatment cost, high in productivity, and is an atmospheric open system, simple in device structure, low in equipment cost, and has a high cost advantage, and a method for manufacturing the same. In addition, it is possible to provide a method for manufacturing a steel structure for hydrogen excellent in hydrogen embrittlement resistance and corrosion resistance by forming a functional membrane obtained by passivating a metal oxide film, on a surface of the steel structure for hydrogen subjected to welding.

### BRIEF DESCRIPTION OF THE DRAWINGS

FIG. 1 is a flow chart illustrating a flow of steps for forming a functional membrane excellent in hydrogen embrittlement resistance and corrosion resistance on a surface of stainless steel of the present invention, by a wet process.

FIG. 2 illustrates a side cross-sectional SEM photograph of the stainless structure coated with the functional membrane excellent in hydrogen embrittlement resistance and corrosion resistance obtained in Embodiment 1 of the present invention.

FIG. 3 illustrates fracture surface SEM photographs, after an SSRT test (under a hydrogen atmosphere of 110 MPa), of the stainless structure coated with the functional membrane excellent in hydrogen embrittlement resistance and corrosion resistance obtained in Embodiment 1 of the present invention.

FIG. 4 illustrates side surface SEM photographs, after the SSRT test (under a hydrogen atmosphere of 110 MPa), of the stainless structure coated with the functional membrane excellent in hydrogen embrittlement resistance and corrosion resistance obtained in Embodiment 1 of the present invention.

FIG. 5 illustrates fracture surface SEM photographs, after the SSRT test (under a hydrogen atmosphere of 110 MPa), of the stainless structure to which only electrolytic polishing was conducted, obtained in Comparative aspect 3.

FIG. 6 illustrates side surface SEM photographs, after the SSRT test (under a hydrogen atmosphere of 110 MPa), of the stainless structure to which only electrolytic polishing was conducted, obtained in Comparative aspect 3.

FIG. 7 illustrates fracture surface SEM photographs, after the SSRT test (under a hydrogen atmosphere of 110 MPa), of the untreated stainless structure obtained in Comparative aspect 4.

FIG. 8 illustrates side surface SEM photographs, after the SSRT test (under a hydrogen atmosphere of 110 MPa), of the untreated stainless structure obtained in Comparative aspect 4.

FIG. 9 illustrates photographs showing a welded part (a) before a corrosion resistance test, and a welded part (b) after the corrosion resistance test, of a welded test specimen coated with the functional membrane excellent in hydrogen embrittlement resistance and corrosion resistance obtained in Embodiment 1 of the present invention.

FIG. 10 illustrates photographs showing the welded part (a) before the corrosion resistance test, and the welded part (b) after the corrosion resistance test, of the welded test specimen to which only electrolytic polishing was conducted, obtained in Comparative aspect 3.

FIG. 11 illustrates photographs showing the welded part (a) before the corrosion resistance test, and the welded part (b) after the corrosion resistance test, of the welded untreated test specimen obtained in Comparative aspect 4.

### MODE FOR CARRYING OUT THE INVENTION

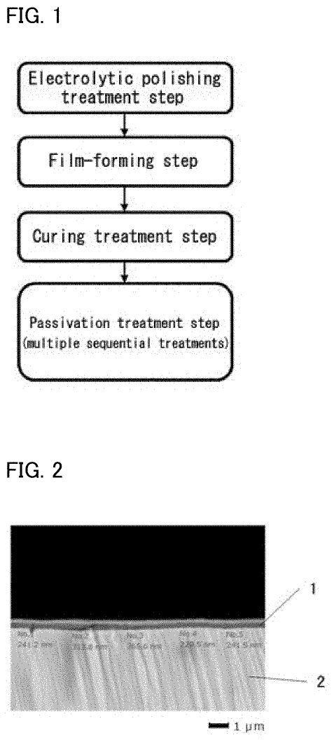

The present invention is stainless steel having hydrogen embrittlement resistance and corrosion resistance, a surface of the stainless steel (including welded stainless steel; the same applies hereinafter) electrolytically polished being coated with a functional membrane excellent in hydrogen embrittlement resistance and corrosion resistance formed by a wet process on. The wet process means that a process of forming a functional membrane excellent in hydrogen embrittlement resistance and corrosion resistance on a surface of stainless steel is performed in a state in which the stainless steel is immersed in an aqueous solution (in a wet state). A method for forming the functional membrane excellent in hydrogen embrittlement resistance and corrosion resistance includes, specifically as illustrated in FIG. 1, a polishing treatment step of electrolytically polishing a surface of the stainless steel, a film-forming step of forming a metal oxide film on the surface of the stainless steel, a curing treatment step of curing the metal oxide film, and a passivation treatment step of passivating the cured metal oxide film with an oxidizing agent. In addition, the present invention is characterized in that the passivation treatment step consists of at least two or more independent passivation treatment steps and it sequentially proceeds with the passivation treatment.

Hereafter, the present invention will be described in the following order: stainless steel, polishing treatment step, film-forming step, curing treatment step, passivation treatment step, hydrogen embrittlement resistance evaluation (SSRT test, fracture surface morphology observation, and hydrogen impermeability) and corrosion resistance evaluation (pitting potential measurement, and corrosion resistance test). However, the present invention is not limited to the following aspects for carrying out the invention.

### 1. Stainless Steel

For stainless steel to be subjected to electrolytic polishing treatment of the present invention, stainless steel used for a high-pressure storage container for storing hydrogen or a high-pressure pipe line for transporting hydrogen can be preferably used. Specifically, it includes ferritic stainless steel, martensitic stainless steel, or austenitic stainless steel. Martensitic stainless steel (for example, 410C, 420, 430, 440C, and 440B) or austenitic stainless steel (for example, 304, 304L, 321, 347, 316L) can be preferably used for a high-pressure storage container or high-pressure pipe line requiring corrosion resistance and high strength.

The stainless steel to be subjected to the electrolytic polishing treatment of the present invention also includes stainless steel that constitutes a steel structure for hydrogen and is subjected to welding joint. For example, a hydrogen storage pressure container is manufactured by weld-jointing each member formed of a stainless steel plate to form a container and acid cleaning the inner face. A high-pressure pipe for transporting hydrogen is manufactured by passing a stainless steel plate in a steel strip state through a welding tube production line. A pipe line is manufactured by weld-jointing a plurality of pipes.

2. Polishing Treatment Step The polishing treatment step removes or reduces any oxide films or impurities (non-metal inclusions) on a surface of a stainless material, or surface defects on the affected layer etc. to have a role as a pretreatment prior to forming a uniform and dense metal oxide film capable of imparting hydrogen embrittlement resistance and corrosion resistance on a surface of stainless steel.

### (2-1) Electrolytic Polishing

Electrolytic polishing can be employed as the polishing treatment step. The electrolytic polishing is a polishing method for smoothening and making glossy a metallic surface by passing direct current in an electrolytic polishing solution with a metal as an anode by an external power supply to dissolve convex parts on the metallic surface having fine concaves and convexes. It has an advantage that a polished surface is clean because it does not make any affected or hardened layers and there are less impurities or contaminants on the polished surface, unlike physical polishing such as buffing.

In an anodic polarization curve (Jacquet curve) in an electrolytic polishing bath, there is a constant current (limiting current) range that does not depend on potentials. In this limiting current range, a thick viscous anodic solution layer (Jacquet layer) is formed near an anode metal to be polished. This solution layer prevents diffusion of eluted cations and it is contemplated that this causes polishing. That is, concaves and convexes on a surface of the anode metal make a difference in concentration gradient in the viscous solution layer, current concentrates on convex parts under the influence of a diffusion current, and the concaves and convexes on the surface disappear to conduct the polishing.

### (2-2) Electrolytic Polishing Solution

A polishing solution used for electrolytic polishing is classified into three systems: a perchloric acid system; a phosphoric acid-sulfuric acid-chromic acid system; and phosphoric acid-sulfuric acid-organic matter system, and the phosphoric acid-sulfuric acid-chromic acid system and the phosphoric acid-sulfuric acid-organic matter system are widely adopted. It includes a single or mixed acid aqueous solution of glacial butyric acid, phosphoric acid, sulfuric acid, nitric acid, chromic acid, sodium dichromate, or the like, and ethylene glycol monoethyl ether, ethylene glycol monobutyl ester or glycerin can be used as an organic matter (additive). These additives have the effect of stabilizing the electrolytic solution and expanding the appropriate electrolysis range against changes in concentration, changes over time, and deterioration due to use.

Specifically, the electrolytic polishing can be performed at 40-90° C. for 3-10 min with a direct current (10-30 V, 3-60 A/dm²) in the electrolytic solution composed of 40-80 vol % phosphoric acid, 5-30 vol % sulfuric acid, 20-70 vol % methanesulfonic acid, 15-20 vol % water, and 0-35 vol % ethylene glycol.

### (2-3) Surface Roughness

It is necessary to suppress the surface roughness of the stainless steel material to be less than 0.1 μm, preferably equal to or less than 0.08 μm, by the electrolytic polishing treatment. This is because the surface roughness affects the film-forming step as mentioned below. As used herein, the “surface roughness” refers to an arithmetic average roughness (Ra) that is defined in JIS B 0601.

### 3. Film-Forming Step

The film-forming step has a role in forming a metal oxide film capable of imparting hydrogen embrittlement resistance and corrosion resistance on the surface of the stainless steel to impart hydrogen embrittlement resistance and corrosion resistance to the stainless steel.

### (3-1) Film Forming

A stainless steel coloring technology is adopted for the formation of the metal oxide film having hydrogen embrittlement resistance and corrosion resistance. The stainless steel coloring technology is a technology of making stainless steel produce a color with an interference color of an anodic oxide film that is formed on a surface of the stainless steel. The thickness of the formed anodic oxide film (“metal oxide film having hydrogen embrittlement resistance and corrosion resistance” in the present invention) is related to a difference in potential between an anode and a reference electrode (chromogenic potential). A method for forming a chromium oxide film in a mixed solution of chromic acid and sulfuric acid, so-called INCO process (refer to Japanese Unexamined Patent Application Publication No. Sho48-011243), is widely adopted.

The thickness of the metal oxide film having hydrogen embrittlement resistance and corrosion resistance that is formed in the present invention, is greater than 100 nm, preferably 110 nm-350 nm, more preferably 150 nm-300 nm.

### (3-2) Film Formation Rate

Controlling the formation rate of the metal oxide film (hereinafter referred to as “film formation rate”) having hydrogen embrittlement resistance and corrosion resistance, improves adhesiveness and uniformity of the film and thus can prevent a thin part of the film or a film defect (pinhole), which may cause reduction in hydrogen embrittlement resistance and corrosion resistance, from occurring.

The film formation rate can be controlled by composition of a chromogenic solution and temperature. As the composition of the chromogenic solution, a mixing ratio of sulfuric acid and chromic acid (chromic acid/sulfuric acid) is preferably 15-30 wt/v % chromic acid to 40-50 wt/v % sulfuric acid. This is because reducing the concentration of chromic acid can decrease the formation rate of the metal oxide film having hydrogen embrittlement resistance and corrosion resistance and thus the thickness of the metal oxide film can be precisely controlled.

The film formation rate can be controlled by a chromogenic potential rate (mV/sec). The chromogenic potential rate is 0.002-0.08 mV/sec, preferably 0.005-0.065 mV/sec. This is because the potential rate of less than 0.002 mV/sec delays the formation of the metal oxide film to reduce the productivity. This is because the potential rate of greater than 0.08 mV/sec makes non-uniform the thickness of the formed metal oxide film having hydrogen embrittlement resistance and corrosion resistance to generate a thin part of the coating film or a coating film defect (pinhole), which may cause reduction in hydrogen embrittlement resistance and corrosion resistance.

### (3-3) Chromogenic Solution

As the composition of the chromogenic solution, a mixing ratio of chromic acid and sulfuric acid (chromic acid/sulfuric acid) is preferably 15-30 wt/v % chromic acid to 40-50 wt/v % sulfuric acid. This is because reducing the concentration of chromic acid can decrease the formation rate of the metal oxide film having hydrogen embrittlement resistance and corrosion resistance and thus the thickness of the metal oxide film having hydrogen embrittlement resistance and corrosion resistance can be precisely controlled. The temperature of the chromogenic solution is 60-90° C.

### (3-4) Manganese Ion

In order to compensate for the formation rate of the metal oxide film having hydrogen embrittlement resistance and corrosion resistance associated with reduction in the concentration of the chromic acid in the chromogenic solution, manganese ions (Mn²⁺) can be added. Manganese salts used in a plating solution include manganese chloride (MnCl₂), manganese sulfate (MnSO₄), manganese nitrate (Mn(NO₃)₂) and the like, one or more kinds of which can be used. The concentration of manganese ions (Mn²⁺) in the plating solution is preferably 0.5-300 mmol/L, more preferably 5-150 mmol/L. This is because the concentration of manganese ions (Mn²⁺) of less than 0.5 mmol/L does not have the effect of promoting the formation of the metal oxide film having hydrogen embrittlement resistance and corrosion resistance and the concentration of manganese ions (Mn²⁺) of greater than 300 mmol/L produces an insoluble residue to affect the formation of the metal oxide film having hydrogen embrittlement resistance and corrosion resistance.

4. Curing Treatment Step The curing treatment step has a role in curing and strengthening the metal oxide film formed on the stainless steel surface and having hydrogen embrittlement resistance and corrosion resistance.

### (4-1) Curing Treatment Step

In the curing treatment step, the stainless steel having the metal oxide film having hydrogen embrittlement resistance and corrosion resistance formed by the film-forming step is used as a cathode, and the film is cured by electrolysis of the cathode. In the metal oxide film having hydrogen embrittlement resistance and corrosion resistance formed by the film-forming step, about 10¹¹ holes of 10-20 nm are distributed per 1 cm². This hole causes reduction in hydrogen embrittlement resistance and corrosion resistance and can be sealed by the curing treatment. In addition, it can also strengthen a loose film.

### (4-2) Curing Treatment Solution

As the curing treatment solution, a mixing ratio of chromic acid and phosphoric acid (chromic acid/phosphoric acid) is preferably 15-30 wt/v % chromic acid to 0.2-0.3 wt/v % phosphoric acid as a reaction accelerator. The treatment is performed at a current density of 0.2-1.0 A/dm² for 5-10 min.

### 5. Passivation Treatment Step

The passivation treatment step has a role in further densifying the cured metal oxide film having hydrogen embrittlement resistance and corrosion resistance to improve the hydrogen embrittlement resistance and corrosion resistance of the film.

### (5-1) Passivation Treatment Step

The passivation treatment is performed in an aqueous solution containing an oxidizing agent capable of passivating (hereinafter referred to as “passivating agent”). The passivating agent includes nitric acid, chromic acid, permanganic acid, molybdic acid, nitrous acid, nitrate salt (e.g., magnesium nitrate), chromate salt (e.g., sodium dichromate).

In addition, addition of sodium dichromate makes pitting potential as mentioned later noble to improve pitting corrosion resistance. The sodium dichromate to be added is preferably 1.5-3.5 wt %.

The passivation treatment method includes (a) a method for immersing in a solution containing nitric acid or another strong oxidizing agent and (b) a method by anodic polarization in a solution containing an oxidizing agent. The method (a) or (b) can be adopted since the present invention is a wet process.

This passivation treatment improves hydrogen embrittlement resistance and corrosion resistance of the metal oxide film formed in the film-forming step and curing treatment step and having a thickness of greater than 100 nm.

### (5-2) Sequential Passivation Treatment

The passivation treatment of the present invention is characterized in that the passivation treatment step consists of at least two or more independent passivation treatment steps and sequentially proceeds with the passivation treatment. This is because performing at least two or more independent passivation treatments with passivating agents different in composition improves hydrogen embrittlement resistance and corrosion resistance of the metal oxide film formed in the film-forming step and curing treatment step and having a thickness of greater than 100 nm.

### (5-3) Thickness of Passivation Film

The thickness of the metal oxide film having hydrogen embrittlement resistance and corrosion resistance of the present invention was measured by SEM observation of a fracture surface on which the film is formed. Conditions for SEM observation of a fracture surface morphology were as follows: Acceleration voltage: 10.0 kV; Detection mode: secondary electron detection; and Magnification: 10000 times. FIG. 2 illustrates a fracture surface SEM photograph in which a cross-section of the stainless structure coated with a functional membrane excellent in hydrogen embrittlement resistance and corrosion resistance, obtained in the embodiment of the present invention, was photographed by a scanning electron microscope (SEM).

### 6. Evaluation of Hydrogen Embrittlement Resistance

The evaluation of hydrogen embrittlement resistance is evaluated by delayed fracture (hydrogen embrittlement) of the stainless steel and hydrogen impermeability by an accelerated test (SSRT test) under hydrogen environment.

### (6-1) SSRT Test

A metallic material used for a high-pressure storage container for storing hydrogen or high-pressure pipeline for transporting hydrogen demands high strength. This increases the susceptibility of delayed fracture (hydrogen embrittlement). The SSRT (Slow Strain Rate Technique) test forcibly breaks by a stress load caused by a low strain rate, so that it is possible to rapidly evaluate the delayed fracture susceptibility in principle irrespective of the test environment with high sensitivity.

### (6-2) Observation of Fractured Section Morphology

The fracture surface and side surface of the test sample after the SSRT test is observed with a scanning electron microscope (SEM).

### (6-3) Hydrogen Impermeability

The hydrogen impermeability is measured by a differential pressure type gas chromatography method according to JIS K7126-1 (differential pressure method) while one side is pressurized and the other side (permeation side) is depressurized with the test specimen as a boundary. The permeated gas (hydrogen) is separated by a gas chromatograph and the permeability is calculated by obtaining the gas permeation amount per hour with a thermal conductivity detector (TCD).

### 7. Evaluation of Pitting Corrosion Resistance

### (7-1) Pitting Potential Measurement

The pitting potential was measured by a method in accordance with JIS G0577 (method for measuring pitting potential of stainless steel in 2014). The potential (V′c 100) corresponding to the current density of 0.1 mA·cm⁻² from the anodic polarization curve in 3.5 wt % NaCl solution (293 K) was measured.

### (7-2) Corrosion Resistance Test

The corrosion resistance test is carried out by a method in accordance with JIS 22371 (neutral salt water spray test in 2000). 5 wt % NaCl solution was continuously sprayed on the test specimen at a temperature inside the bath of 35° C. and the presence or absence of the formation of rust was observed over time every 24 hours.

### EXAMPLES

Next, embodiments providing the effect of the present invention are shown as examples. In addition, the summary is shown in Table 1 (test sample preparation conditions) and Table (test sample evaluation results).

TABLE 1

| | | | | | | | | Curing | Passivation |
|---|---|---|---|---|---|---|---|---|---|
| | | | | | | | | treatment | treatment |
| | | | Film-forming step | | | | | step | step |
| | | | Chromic | Chromogenic | | | | Chromic | Treatment 1 |
| | | Electrolytic | acid/ | potential | | | | acid/ | Nitric |
| | Steel | polishing | sulfuric | rate | Temperature | Time | | phosphoric | acid |
| | material | step | acid (*1) | (mV/sec) | (° C.) | (min) | Color | acid (*1) | (*2) |
| Example 1 | SUS304 | With | 25/50 | 0.011 | 65 | 35 | Green | 25/0.25 | 25 |
| Example 2 | SUS304 | With | 25/50 | 0.011 | 65 | 35 | Green | 25/0.25 | 25 |
| Comparative | SUS304 | With | 25/50 | 0.011 | 65 | 35 | Green | 25/0.25 | 25 |
| example 1 | | | | | | | | | |
| Comparative | SUS304 | With | 25/50 | 0.011 | 65 | 35 | Green | 25/0.25 | Without |
| example 2 | | | | | | | | | |
| Comparative | SUS304 | With | Without | | | | | Without | Without |
| example 3 | | | | | | | | | |
| Comparative | SUS304 | Without | Without | | | | | Without | Without |
| example 4 | | | | | | | | | |
| | | | Passivation treatment step | | | | | | |
| | | | Treatment 1 | | | Treatment 2 | | | Thickness |
| | | | Na | Tem- | | Mg | Tem- | | of |
| | | | dichromate | perature | Time | nitrate | perature | Time | passivation |
| | | | (*1) | (° C.) | (mm) | (*1) | (° C.) | (min) | film (nm) |
| | | Example 1 | 2.5 | 25 | 10 | 50 | 60 | 360 | 260 |
| | | Example 2 | 1.0 | 25 | 10 | 50 | 60 | 360 | — |
| | | Comparative | 2.5 | 25 | 10 | Without | | | — |
| | | example 1 | | | | | | | |
| | | Comparative | Without | | | | | | — |
| | | example 2 | | | | | | | |
| | | Comparative | Without | | | | | | — |
| | | example 3 | | | | | | | |
| | | Comparative | Without | | | | | | — |
| | | example 4 | | | | | | | |

*1: The concentration of chromic acid, sulfuric acid, phosphoric acid, Na dichromate is wt/v %.
*2: The concentration of nitric acid is v/v %.

TABLE 2

| | | | | | | | | Corrosion resistance | |
|---|---|---|---|---|---|---|---|---|---|
| | | | | | | | | evaluation | |
| | Hydrogen ecbrittlement resistance evaluation | | | | | | | | Anticorrosion test |
| | SSRT test | | | | Hydrogen impermeability | | | Pitting | (welded product) |
| | Under hydrogen | | Relative | | Hydrogen permeability ratio | | | potential | Neutral salt |
| | 110 MPa atmosphere | | reduction | | (treated product/substrate) | | | V′ _{c}100 | water spray test |
| | Reduction of area (%) | | of area | | 300° C. | 400° C. | 500° C. | (V, SCE) | (JIS Z2371) |
| Example 1 | 76.4 | 68.7 | 0.93 | 0.84 | 1.67 × 10⁻² | 1.05 × 10⁻² | 1.27 × 10⁻² | 0.85 | No rust for a |
| | | | | | | | | | continuous period |
| | | | | | | | | | of 528 hours |
| Example 2 | — | — | | | — | — | — | 0.77 | — |
| Comparative | — | — | | | — | — | — | 0.65 | — |
| example 1 | | | | | | | | | |
| Comparative | — | — | | | 2.15 × 10⁻² | 1.39 × 10⁻² | 2.66 × 10⁻² | 0.56 | — |
| example 2 | | | | | | | | | |
| Comparative | 56.4 | 59.2 | 0.69 | 0.73 | 4.06 × 10⁻² | 6.37 × 10⁻² | 4.14 × 10⁻² | 0.47 | No rust for a |
| example 3 | | | | | | | | | continuous period |
| | | | | | | | | | of 528 hours |
| Comparative | 47.4 | 52.2 | 0.58 | 0.64 | 1.00 | 1.00 | 1.00 | 0.25 | Rust formation for |
| example 4 | | | | | | | | | a continuous |
| | | | | | | | | | period of 48 hours |

### 1. Test Sample Preparation

### Example 1

The following electrolytic polishing treatment, film-forming treatment, curing treatment, and passivation treatment were sequentially carried out to prepare a test sample of the present invention (hereinafter referred to as “Example 1 product”).

### (1) Electrolytic Polishing Treatment

Electrodes (+) were attached to a stainless steel weld test specimen, a round bar test specimen (SUS304, φ 4 mm×20 mm) based on ASTM E8 for SSRT test and for hydrogen impermeability evaluation (SUS304, φ 35 mm, thickness 0.1 mm), and electrolytic polishing was carried out under the following treatment condition to prepare a polished product.

### [Electrolytic Polishing Treatment Condition]

Electrolytic polishing solution composition: Phosphoric acid 450 ml/L, methanesulfonic acid 450 ml/L, ethylene glycol 0.2 ml/L

Treatment temperature: 85° C.

Treatment time: 5 min

Current density: 20 A/dm²

### (2) Surface Roughness Measurement

The arithmetic average roughness (Ra) of the polished product was measured with a surface roughness measuring instrument (Form Talysurf PGI-PLS manufactured by Taylor Hobson). The surface roughness was 0.08 μm.

### (3) Film-Forming Treatment

The polished product was subjected to the film-forming treatment (chromogenic treatment) under the following condition to prepare a film-formed product.

### [Film-Forming Treatment Condition]

Chromogenic solution composition: Chromium oxide 250 g/L, sulfuric acid 500 g/L, manganese sulfate 6.3 g/L

Treatment temperature: 65° C.

Treatment time: 35 min

Chromogenic potential rate: 0.001 mV/sec

### (4) Curing Treatment

The film-formed product was subjected to the curing treatment under the following condition to prepare a cured product.

### [Curing Treatment Condition]

Curing solution composition: Chromium oxide 250 g/L, phosphoric acid 2.5 g/L

Treatment temperature: 25° C.

Treatment time: 10 min

Current density: 0.5 A/dm²

### (5) Passivation Treatment

The cured product was subjected to the sequential passivation treatments under the following condition 1 and condition 2 to prepare a passivated product.

### [Passivation Treatment Condition 1]

Passivation solution composition: Nitric acid 25 vol %, sodium dichromate 2.5 wt %

Treatment temperature: 25° C.

Treatment time: 10 min

### [Passivation Treatment Condition 2]

Passivation solution composition: magnesium nitrate 50 vol %

Treatment temperature: 60° C.

Treatment time: 360 min

### (6) Passivation Film Thickness

The film thickness by SEM observation of the cross-sectional morphology was measured at five points (241 nm, 314 nm, 266 nm, 230 nm, 242 nm) as illustrated in FIG. 2, and the average thereof was 260 nm.

### Example 2

The following electrolytic polishing treatment, film-forming treatment, curing treatment, and passivation treatment were sequentially carried out to prepare a test sample of the present invention (hereinafter referred to as “Example 2 product”).

### (1) Electrolytic Polishing Treatment

Electrodes (+) were attached to a stainless steel weld test specimen, for SSRT test (SUS304, φ 4 mm×20 mm) and for hydrogen impermeability evaluation (SUS304, φ 35 mm, thickness 0.1 mm), and electrolytic polishing was carried out under the following treatment condition to prepare a polished product.

### [Electrolytic Polishing Treatment Condition]

Electrolytic polishing solution composition: Phosphoric acid 450 ml/L, methanesulfonic acid 450 ml/L, ethylene glycol 0.2 ml/L

Treatment temperature: 85° C.

Treatment time: 5 min
Current density: 20 A/dm²

### (2) Surface Roughness Measurement

The arithmetic average roughness (Ra) of the polished product was measured with a surface roughness measuring instrument (Form Talysurf PGI-PLS manufactured by Taylor Hobson). The surface roughness was 0.08 μm.

### (3) Film-Forming Treatment

The polished product was subjected to the film-forming treatment (chromogenic treatment) under the following condition to prepare a film-formed product.

### [Film-Forming Treatment Condition]

Chromogenic solution composition: Chromium oxide 250 g/L, sulfuric acid 500 g/L, manganese sulfate 6.3 g/L

Treatment temperature: 65° C.

Treatment time: 35 min

Chromogenic potential rate: 0.001 mV/sec

### (4) Curing Treatment

The film-formed product was subjected to the curing treatment under the following condition to prepare a cured product.

### [Curing Treatment Condition]

Curing solution composition: Chromium oxide 250 g/L, phosphoric acid 2.5 g/L

Treatment temperature: 25° C.

Treatment time: 10 min

Current density: 0.5 A/dm²

### (5) Passivation Treatment

The cured product was subjected to the sequential passivation treatments under the following condition 1 and condition 2 to prepare a passivated product.

### [Passivation Treatment Condition 1]

Passivation solution composition: Nitric acid 25 vol %, sodium dichromate 2.5 wt %

Treatment temperature: 25° C.

Treatment time: 10 min

### [Passivation Treatment Condition 2]

Passivation solution composition: Magnesium nitrate 50 vol %

Treatment temperature: 60° C.

Treatment time: 360 min

### Comparative Example 1

The same treatments as Example 1 were carried out except the passivation treatment was implemented only under the condition 1, to prepare a test sample and it was made Comparative example 1 (hereinafter referred to as “Comparative example 1 product”).

### Comparative Example 2

The same treatments as Example 1 were carried out except the passivation treatment was not carried out, to prepare a test sample and it was made Comparative example 2 (hereinafter referred to as “Comparative example 2 product”).

### Comparative Example 3

Only the same electrolytic polishing treatment as Example 1 was carried out, to prepare a test sample and it was made Comparative example 3 (hereinafter referred to as “Comparative example 3 product”).

### Comparative Example 4

A test sample on which the treatments described in Example 1 were not carried out, was prepared and made Comparative example 4 (hereinafter referred to as “Comparative example 4 product”).

### 2. Hydrogen Embrittlement Resistance Evaluation

### (1) SSRT Test

For Example 1 product, Comparative example 3 product and Comparative example 4 product, a reduction of area (%) was measured by an SSRT test (under hydrogen of 110 MPa) in order to evaluate hydrogen embrittlement. Here, the reduction of area refers to the ratio of the cross-sectional area of a constricted and fractured section to the original cross-sectional area.

The reduction of area under hydrogen of 110 MPa was 76.4%, 68.7% in Example 1 product, 56.4%, 59.2% in Comparative example 3 product, and 47.4%, 52.2% in Comparative example 4 product.

### [Test Condition]

Strain rate: 4.17×10⁻⁵/sec

Test temperature: 16° C.

### <Relative Reduction of Area>

In addition, a measure of hydrogen embrittlement resistance is indicated by a relative value of the reduction of area (a value obtained by dividing a reduction of area under hydrogen by a reduction of area under an insert gas; hereinafter, referred to as “relative reduction of area”). The relative reduction of area of Example 1 product of the present invention (the value obtained by dividing the reduction of area under a hydrogen atmosphere of 110 MPa by the reduction of area under a nitrogen atmosphere of 10 MPa) is 0.93, 0.84, which is higher than those of Comparative example 3 product (0.69, 0.73) and Comparative example 4 product (0.58, 0.64). Therefore, the embodiment of the present invention is found to be excellent in hydrogen embrittlement resistance.

### (2) Observation of Fractured Section Morphology

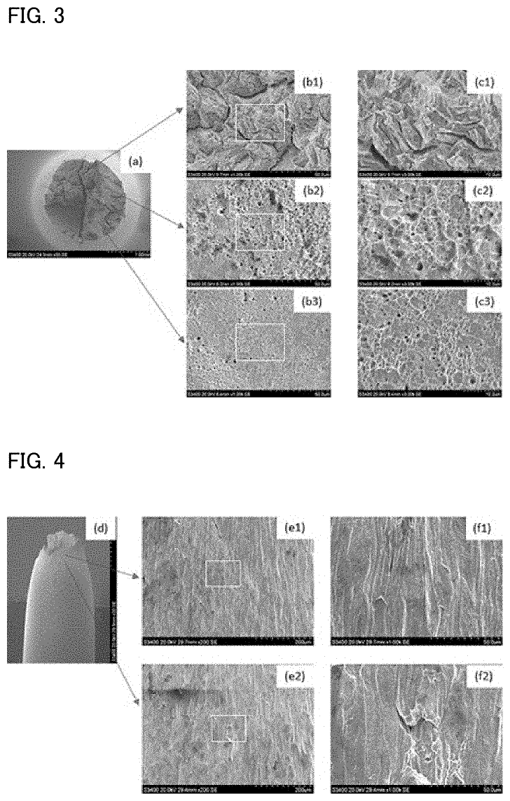

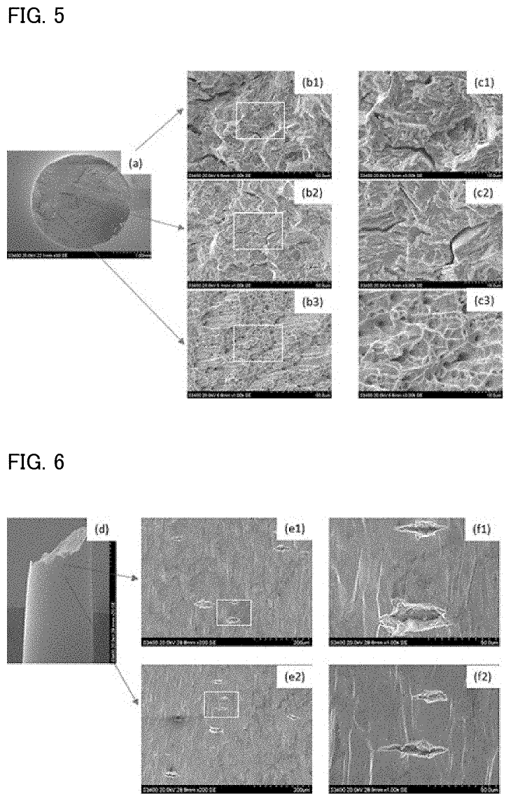

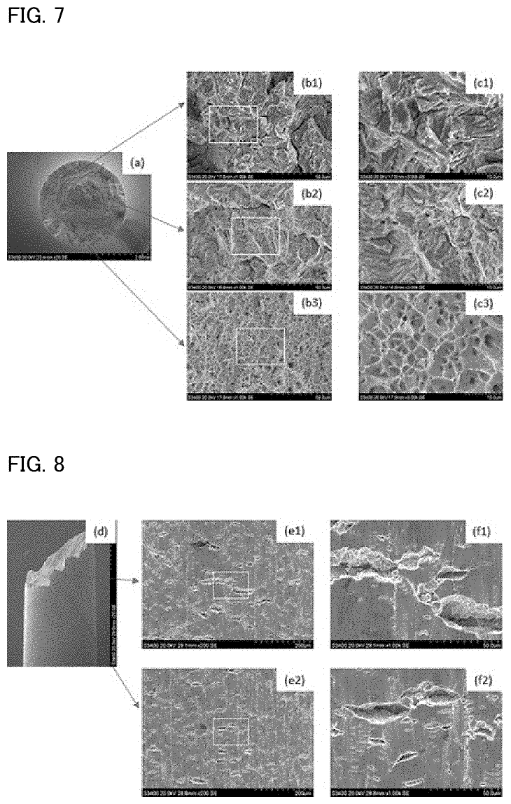

For the fractured section of the test specimen subjected to the SSRT test, SEM (Hitachi S-3400N) observation of the fracture surface and side face was conducted. FIG. 3 and FIG. 4 are for Example 1 product, FIG. 5 and FIG. 6 are for Comparative example 3 product, and FIG. 7 and FIG. 8 are for Comparative example 4 product. In addition, the drawings include (a) entire fracture surface (magnification: 20 times), (b1-b3) fracture surface (magnification: 1000 times), (c1-c3) fracture surface (magnification: 3000 times), (d) entire side surface (magnification: 20 times), (e1-e2) side surface (magnification: 1000 times), (f1-f2) side surface (magnification: 3000 times).

The fracture surface observation showed that Example 1 product that is the embodiment of the present invention included shear and ductile fracture surfaces, but the number of the shear fracture surfaces was small and many of them were the ductile fracture surfaces. On the other hand, in both of Comparative example 3 product and Comparative example 4 product that are comparative aspects, many of them were the shear fracture surfaces.

In addition, the side surface observation showed that Example 1 product that is the embodiment of the present invention had a larger constriction due to extension than the comparative aspects (Comparative example 3 product and Comparative example 4 product), didn't have a trace of peeling of the passivation film, and had high adhesiveness of the passivation film.

### (3) Hydrogen Impermeability Evaluation

A high temperature hydrogen permeation test was performed on Example 1 product and Comparative example 2 product by a differential pressure type gas chromatography method according to JIS K7126-1 (differential pressure method) to obtain a hydrogen permeability ratio (Example products/Comparative example 4 product).

In each temperature condition (300° C., 400° C., 500° C.), Example 1 product has a hydrogen permeability ratio equal to or less than 2.0×10⁻² and is found to have a high hydrogen barrier property.

### [Test Condition]

Test sample (φ 35 mm, thickness 0.1 mm)

Differential pressure: 400 kPa

Temperature: 300° C., 400° C., 500° C.

### 3. Corrosion Resistance Evaluation

### 1) Pitting Corrosion Resistance Evaluation (Pitting Potential)

A measurement was made on Example products (Example 1-Example 2) and Comparative example products (Comparative example 1-Comparative example 4) by a method in accordance with JIS G0577 (method for measuring pitting potential of stainless steel in 2014). Both the pitting potentials of Example products are significantly higher than those of Comparative example products.

### (2) Corrosion Resistance Test

The corrosion resistance of Example 1 product, Comparative example 3 product, and Comparative example 4 product which are subjected to welding, was evaluated by a method in accordance with JIS 22371 (neutral salt water spray test in 2000).

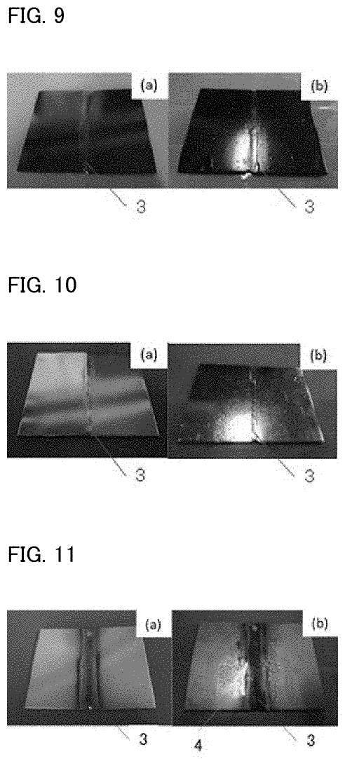

In Example 1 product (FIG. 9) and Comparative example 3 product (FIG. 10), no rust was formed even after a lapse of 528 hours. On the other hand, in Comparative example 4 product (FIG. 11), rust was formed after a lapse of 48 hours.

### [Test Condition]

5 wt % NaCl solution was continuously sprayed on the test specimen at a temperature inside the bath of 35° C. and the presence or absence of the formation of rust was observed over time every 24 hours.

### INDUSTRIAL APPLICABILITY

According to the present invention, it is possible to provide stainless steel that can be used for a high-pressure storage container for storing hydrogen or a high-pressure pipe line for transporting hydrogen providing for a storage and transportation technology for a stable supply of hydrogen, in order to realize a hydrogen energy based society where hydrogen is utilized as an environment-friendly energy source for the next generation.

### DESCRIPTION OF REFERENCE NUMERALS

1 Passivation film
2 Stainless steel
3 Welded part
4 Rust

1. Stainless steel having hydrogen embrittlement resistance, a surface of electrolytically polished stainless steel being coated with a film obtained by passivating a metal oxide film, wherein a relative reduction of area (under a hydrogen atmosphere of 110 MPa/under a nitrogen atmosphere of 10 MPa) in an SSRT test (strain rate 4.17×10⁻⁵/sec, test temperature 16° C.) is equal to or greater than 0.8.

2. The stainless steel having hydrogen embrittlement resistance according to claim 1, a relative reduction of area (under a hydrogen atmosphere of 110 MPa/under a nitrogen atmosphere of 10 MPa) in an SSRT test (strain rate 4.17×10⁻⁵/sec, test temperature 16° C.) being equal to or greater than 0.8, wherein the electrolytically polished stainless steel is stainless steel subjected to welding.

3. A method for manufacturing stainless steel having hydrogen embrittlement resistance, the stainless steel being coated with a film obtained by passivating a chromium oxide film, a relative reduction of area (under a hydrogen atmosphere of 110 MPa/under a nitrogen atmosphere of 10 MPa) in an SSRT test (strain rate 4.17× 10⁻⁵/sec, test temperature 16° C.) being equal to or greater than 0.8, the method comprising:
a polishing treatment step of electrolytically polishing a surface of the stainless steel;
a film-forming step of immersing the polished stainless steel in a treatment solution comprising a mixed solution containing chromic acid and sulfuric acid to form a chromium oxide film on the surface of the stainless steel;
a curing treatment step of immersing the chromium oxide film formed in the film-forming step in a treatment solution comprising a mixed solution containing chromic acid and phosphoric acid to cure the chromium oxide film; and
a passivation treatment step of immersing the chromium oxide film cured in the curing treatment step in a treatment solution comprising a passivating agent to passivate the chromium oxide film,
wherein the passivation treatment step consists of at least two or more independent passivation treatment steps.

4. The method for manufacturing stainless steel having hydrogen embrittlement resistance, a relative reduction of area (under a hydrogen atmosphere of 110 MPa/under a nitrogen atmosphere of 10 MPa) in an SSRT test (strain rate 4.17×10⁻⁵/sec, test temperature 16° C.) being equal to or greater than 0.8, according to claim 3, wherein the two or more independent passivation treatment steps are each a passivation treatment step of immersing in treatment solutions comprising passivating agents different in component to passivate the chromium oxide film.

5. The method for manufacturing stainless steel having hydrogen embrittlement resistance, a relative reduction of area (under a hydrogen atmosphere of 110 MPa/under a nitrogen atmosphere of 10 MPa) in an SSRT test (strain rate 4.17×10⁻⁵/sec, test temperature 16° C.) being equal to or greater than 0.8, according to claim 4, wherein the electrolytically polished stainless steel is stainless steel subjected to welding.
